(19) United States
(12) Patent Application Publication
(10) Pub. No.: US 2012/0055968 A1
(43) Pub. Date: Mar. 8, 2012

(54) RATCHET BINDER STORAGE RACK

(76) Inventors: Berylin Parker, San Angelo, TX (US); David Stamps, San Angelo, TX (US)

(21) Appl. No.: 12/878,030

(22) Filed: Sep. 8, 2010

(51) Int. Cl. B60R 9/00

(52) U.S. Cl. 224/571

(57) ABSTRACT

A ratchet rack for storing a plurality of ratchet binders comprising: a center section; a side section extending from each side of the center section; a mounting section perpendicularly extending from each side section, where said mounting section include a means to enable the mounting of the rack onto a truck or trailer frame; and an opening between the side sections, where said opening provides a means for the insertion of the plurality of ratchet binders. The ratchet rack may further include a security plate that covers the ratchet binders. The security plate may include a mounting plate, a top plate, a front plate and a hinge. The hinge joins the top plate and mounting plate and the front plate extends at a 90-degree angle from the top plate.

### BACKGROUND OF THE INVENTION

1. Field of Invention

The present invention relates to a ratchet rack that is used to store ratchet binders on an over-the-road truck.

2. Description of Related Art

Over-the-road transportation is used to transport numerous goods and packages. Most over-the-road trucking involves the use of large semi-truck tractors and trailers that transport the cargo and shipments to destinations throughout the country. Truckers transport all types of goods and packages. Some cargo involves hazardous materials, food products, products that must be refrigerated in a reefer and other cargo may be transported on an open trailer and secured through the use of binders and ratchets. Some of the large cargo that is transported on open trailers must be bound and securely attached to the trailer to avoid the cargo from accidentally coming off the trailer during transport. Many truckers use large ratchet binders and chains to secure the cargo so that it may be securely fastened to the trailer. Many of the ratchet binders are used for heavy duty transport and many times a trucker may use several on one load. The ratchet binders provide a means to tighten, adjust and secure cargo and therefore are essential in many trucking applications.

One problem in using ratchet binders is that once the cargo is removed the trucker must secure the binders for transport in order to pick up the next load or cargo. Presently there are limited devices used to store ratchet binders and therefore many times truckers may lose binders due to improper fastening during transport of the binders. It would therefore be advantageous to have a device specifically designed to store ratchet binders so that the binders may be securely transported when not in use. It further would be advantageous to have a device that is securely attached to the trailer or truck frame that allows for storage of the binders outside of the interior cab of the truck.

### SUMMARY OF THE INVENTION

The present invention relates to a ratchet rack for storing a plurality of ratchet binders comprising: a center section; a side section extending from each side of the center section; a mounting section perpendicularly extending from each side section, where said mounting section include a means to enable the mounting of the rack onto a truck or trailer frame; and an opening between the side sections, where said opening provides a means for the insertion of the plurality of ratchet binders. The ratchet rack may further include a security plate that covers the ratchet binders. The security plate may include a mounting plate, a top plate, a front plate and a hinge. The hinge joins the top plate and mounting plate and the front plate extends at a 90-degree angle from the top plate.

### BRIEF DESCRIPTION OF DRAWINGS

FIG. 1A depicts a ratchet rack according to the present invention.

FIG. 1B depicts a side view of the ratchet rack according to the present invention.

FIG. 1C depicts a top view of the ratchet rack according to the present invention.

FIG. 2A depicts a security plate according to the present invention.

FIG. 2B depicts a side view of the security plate according to the present invention.

FIG. 3 depicts a prospective view of the ratchet rack according to the present invention.

### DETAILED DESCRIPTION

The present invention relates to a ratchet rack that is mounted onto a frame of a truck or trailer to secure and transport the ratchet binders. The ratchet rack according to the present invention includes a security plate that secures the ratchet binders onto the rack and provides a means to lock or secure the binders while the binders are being transported. The ratchet rack according to the present invention may be made of steel or other hard metal and is configured to allow for the insertion of ratchets, chain and T-handle type binders.

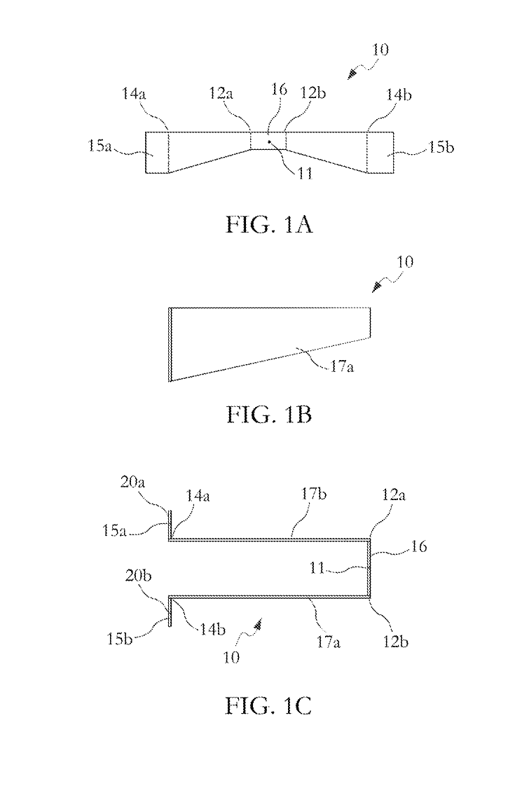

In reference to FIG. 1A, a ratchet rack 10 is depicted. The ratchet rack 10 includes a center section 16 and bends are provided each side of the center section 16 to configure the rack for mounting onto a truck frame. As shown the center section has Bends 12a, 12b equally spaced from a hole 11. To the left of the center section is a left mounting section 15a which is designated with a left bend 14 and a right mounting section 15b designated by a bend 14b. The rack is manufactured in this configuration where each side and increases to a larger height from the center section 16 toward each respective mounting section 15a, 15b. FIG. 1B depicts a side view of the ratchet rack 10 according to the present invention. The side view of the rack 10 shows the rack 10 after it has been bent at the designated areas depicted in FIG. 1A. This particular side view shows a first side 17a from the center section 16 back to the mounting section 15.

FIG. 1C depicts a top view of the ratchet rack 10 according to the present invention. The top view shows how the rack is configured once it is bent at these appropriate positions and available for mounting onto a frame of a truck or trailer. The rack 10 includes a first side 17a and a second side as 17b that extend from the center section 16. This configuration leaves an opening 18 for the insertion of ratchet binders for storage therein. The mounting sections 15a, 15b each include a mounting hole 20a, 20b for the insertion of a means to mount rack 10 onto the frame of a truck or a trailer. Each bend point is designated and shown in the top view of FIG. 1C. Further the center section 16 includes a hole 11 which provides a means for securing a security plate over the ratchet binders once they have been inserted through the opening 18.

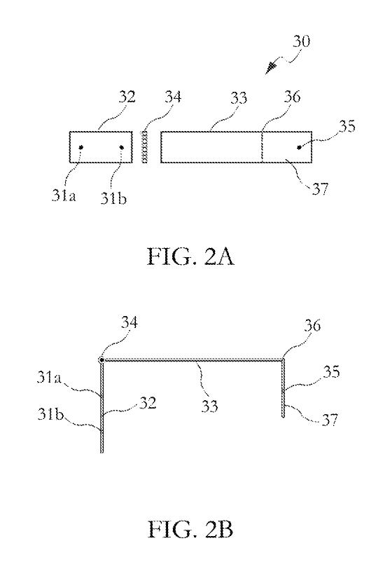

FIG. 2A depicts a sectional view of a security plate 30 used in conjunction with the ratchet rack 10 according to the present invention. The security plate 30 includes three sections a mounting plate 32, a top plate 33 and a front plate 37. A hinge 34 is used to join the mounting plate 32 to the top plate 33. The hinge 34 allows the rotation of the top plate up to at least a 90-degree angle to allow the insertion of ratchet binders into the opening 18 provided in the ratchet rack 10. The security plate 30 is depicted in a side view in FIG. 2B. As shown, the mounting plate 32 includes two mounting holes 31a, 31b that are used to secure the security plate 30 onto the frame of a truck or trailer. The mounting plate 32 may be placed in between the mounting sections 15a, 15b of the ratchet rack 10 and therefore the top plate 33 is aligned vertically with the opening 18 of the ratchet rack 10. This alignment allows for the security plate 30 to be rotated in a position where the top plate 33 is horizontal and the mounting plate 32 is vertical and substantially parallel to the front plate 37. The front plate 37 may include a hole 35 where the hole 35 provides a means to align with the hole 11 of the center section 16 of the ratchet rack 10. This alignment of hole 11 and hole 35 may provide a means to secure the security plate in a stationary position over a plurality of ratchet binders stored within the ratchet rack 10.

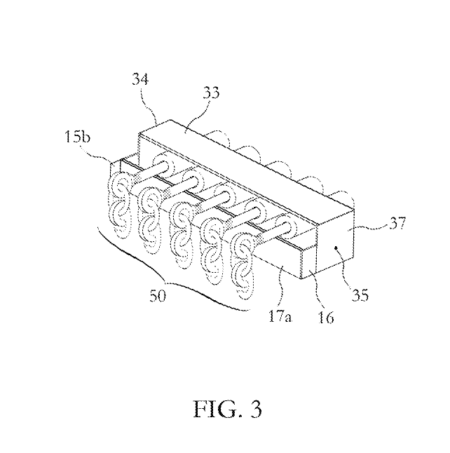

FIG. 3 depicts a perspective view of the ratchet rack 10 with a plurality of ratchet binders 50 stored therein. As depicted the ratchet rack's 10 first side 17a and center section 16 are shown where the security plate 30 fits over the plurality of ratchet binders 50. The top plate 33 extends across the length of the plurality of ratchet binders 50 and the front plate 37 joins and aligns with the center section 16 of the ratchet rack 10.

The ratchet rack according to the present invention provides a safe and secure method to secure and store a plurality of ratchet binders when not in use. The ratchet rack helps the trucker to secure these ratchet binders to avoid losing the ratchet binders due to misplacement or other problems concerning the storage of the ratchet binders when not in use. The ratchet rack is easy to use and readily available to secure to the frame of a truck or a trailer due to the configuration provided for respective ratchet rack and security plate used in conjunction with it. The instant invention has been shown and described in what it considers to be the most practical and preferred embodiments. It is recognized, however, that departures may be made there from within the scope of the invention and that obvious modifications will occur to a person skilled in the art.

What is claimed is:

1. A ratchet rack for storing a plurality of ratchet binders comprising:
a. a center section;
b. a side section extending from each side of the center section;
c. a mounting section perpendicularly extending from each side section, where said mounting section include a means to enable the mounting of the rack onto a truck or trailer frame; and
d. an opening between the side sections, where said opening provides a means for the insertion of the plurality of ratchet binders.

2. The ratchet rack according to claim 1 further including a security plate where said security plate covers the ratchet binders.

3. The ratchet rack according to claim 2, where said security plate includes a mounting plate, a top plate, a front plate and a hinge, where the hinge joins the top plate and mounting plate and the front plate extends at a 90-degree angle from the top plate.

4. The ratchet rack according to claim 1, where the means to enable the mounting of the rack includes at least one hole in each mounting section.

5. The ratchet rack according to claim 3, where the front plate includes a hole and the center section includes a hole, where the front plate hole and center section hole align.

6. The ratchet rack according to claim 3, where the mounting plate of the security plate includes a hole.
